(19) United States
(12) Patent Application Publication
(10) Pub. No.: US 2024/0292051 A1
(43) Pub. Date: Aug. 29, 2024

(54) TRANSMISSION RECEPTION SYSTEM, TRANSMISSION SYSTEM, RECEPTION SYSTEM, AND TRANSMISSION RECEPTION METHOD

(71) Applicant: NIPPON TELEGRAPH AND TELEPHONE CORPORATION, Tokyo (JP)

(72) Inventors: Eiichiro MATSUMOTO, Musashino-shi, Tokyo (JP); Shinji FUKATSU, Musashino-shi, Tokyo (JP); Hiromu MIYASHITA, Musashino-shi, Tokyo (JP); Maiko IMOTO, Musashino-shi, Tokyo (JP)

(73) Assignee: NIPPON TELEGRAPH AND TELEPHONE CORPORATION, Tokyo (JP)

(21) Appl. No.: 18/571,252

(22) PCT Filed: Jun. 23, 2021
(86) PCT No.: PCT/JP2021/023733

§ 371 Date: Dec. 18, 2023

(51) Int. Cl. H04N 21/43

(52) U.S. Cl. CPC H04N 21/4307

(57) ABSTRACT

According to an embodiment, a transfer system includes a transmission system, a reception system, an information collection unit, and a synchronization control unit. The transmission system can transmit video data and audio data to a connected network. The reception system can receive video data and audio data via the network. The information collection unit is provided in the transmission system or the reception system, and associates a determination result on necessity of synchronization between a video and an audio with a determination item to collect the determination result and the determination item as synchronization control data. The synchronization control unit is provided in the transmission system or the reception system and selects any one of synchronous audio data capable of outputting an audio in synchronization with a video and asynchronous audio data capable of outputting the audio independently of the video, on the basis of the synchronization control data.

### TECHNICAL FIELD

The present invention relates to a transfer system, a transmission system, a reception system, and a transfer method.

### BACKGROUND ART

In a multimedia content transfer system, a transmission system synchronizes and transmits a video and audio input from a camera and a microphone to a reception system that can communicate via a network. The reception system displays the video on a video display device and reproduces the audio from a speaker on the basis of on the transmitted video and audio. For example, in a case in which a video and audio are shared between remote systems in real time, it is unlikely for problems to occur when the systems work together and video and audio transfer delay does not exceed 50 milliseconds. Further, since the video and the audio are synchronized with each other, a degree of audio delay is the same as a degree of video delay. Therefore, there is a demand for a transfer system capable of suppressing a delay associated with a video and audio.

### CITATION LIST

### Patent Literature

[PTL 1] Japanese Patent No. 5595348

### Non Patent Literature

[NPL 1] Yu Nishibori, et al., “Study and Experiment of Recognition of the Delay in Musical Performance with Delay,” IPSJ SIG Technical Reports), Dec. 21, 2003, No. 127 (2003-MUS-053), p. 37-42

### SUMMARY OF INVENTION

### Technical Problem

An object of the present invention is to provide a transfer system, a transmission system, a reception system, and a transfer method capable of suppressing delays associated with a video and audio.

### Solution to Problem

According to an embodiment, a transfer system includes a transmission system, a reception system, an information collection unit, and a synchronization control unit. The transmission system can transmit video data and audio data to a connected network. The reception system can receive video data and audio data via the network. The information collection unit is provided in the transmission system or the reception system, and associates a determination result on necessity of synchronization between a video and audio with a determination item to collect the determination result and the determination item as synchronization control data. The synchronization control unit is provided in the transmission system or the reception system and selects any one of synchronous audio data capable of outputting audio in synchronization with a video and asynchronous audio data capable of outputting the audio independently of the video, on the basis of the synchronization control data.

### Advantageous Effects of Invention

According to the embodiments, it is possible to provide a transfer system, a transmission system, a reception system, and a transfer method capable of suppressing delays associated with a video and audio.

### BRIEF DESCRIPTION OF DRAWINGS

FIG. 1 is a block diagram schematically illustrating a transfer system according to an embodiment.

FIG. 2 is a block diagram schematically illustrating a hardware configuration of a transmission system and a reception system of the transfer system according to the embodiment.

FIG. 3 is a flowchart illustrating an example of processing that is executed by a synchronization control unit of the transfer system according to the embodiment.

FIG. 4 is a block diagram schematically illustrating a modification example of the transfer system according to the embodiment.

### DESCRIPTION OF EMBODIMENTS

Embodiments of the present invention will be described in detail with appropriate reference to the drawings.

The transfer system 1 according to the embodiment is used, for example, when sports, entertainment, or the like is watched at a remote place. When places (bases) at which the sports, entertainment, or the like is watched are different, it is necessary to transfer a video and audio of the sports, entertainment, or the like to the places at which the sports, entertainment, or the like is watched without as little delay as possible in order for the viewers to enjoy the sports, entertainment, or the like at the same time. However, since a video and audio are generally transferred in synchronization, a delay in video transfer results in a delay in audio transfer. As a result, it is sometimes difficult for viewers at remote places to enjoy sports, entertainment, or the like at the same time (together). The present transfer system 1 of the embodiment selects any one of synchronous audio data capable of outputting audio in synchronization with a video and asynchronous (independent) audio data capable of outputting audio independently of a video, on the basis of synchronous control data. Accordingly, viewers of sports, entertainment, or the like can view synchronized video and audio at a timing when synchronization of the video and the audio is required. For example, when a video of a player playing a game is being reproduced, a video and audio are transferred in synchronization, and thus viewers can watch the game without discomfort. On the other hand, when it is not necessary to synchronize the video and the audio, such as when a video or the like of audience seats is being reproduced, the video and the audio are transferred without being synchronized, thereby suppressing an audio delay to a predetermined threshold value or less. This makes it possible for viewers at remote places to cheer together.

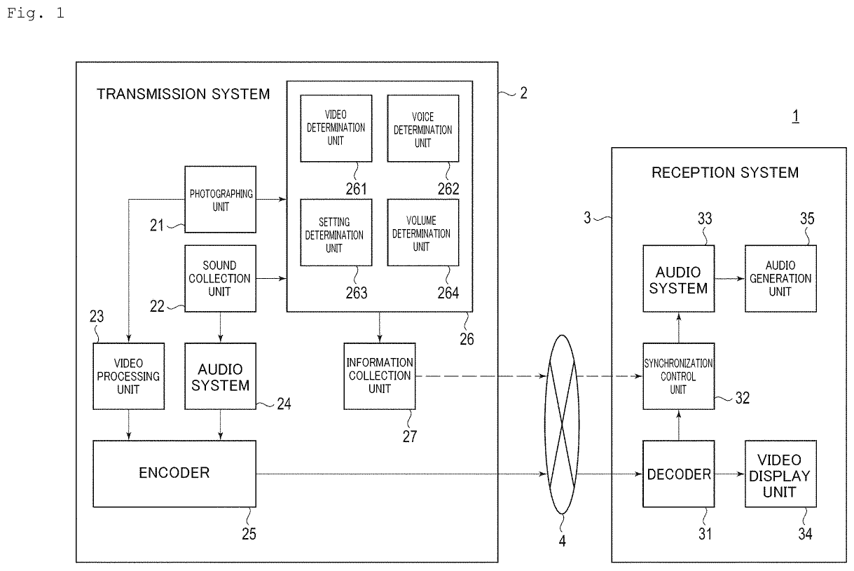

FIG. 1 is a block diagram schematically illustrating a transfer system according to an embodiment. The transfer system 1 includes a transmission system 2 and a reception system 3. The transmission system 2 includes a photographing unit 21, an audio collection unit 22, a video processing unit 23, an audio system 24, an encoder 25, a determination unit 26, and an information collection unit 27. The determination unit 26 includes a video determination unit 261, an audio determination unit 262, a setting determination unit 263, and a volume determination unit 264. The reception system 3 includes a decoder 31, a synchronization control unit 32, an audio system 33, a video display unit 34, and an audio generation unit 35. The transmission system 2 and the reception system 3 can communicate with each other via a network 4. The network 4 is, for example, the Internet (registered trademark). A dashed line in FIG. 1 indicates a path through which synchronization control data, which will be described below, is transmitted.

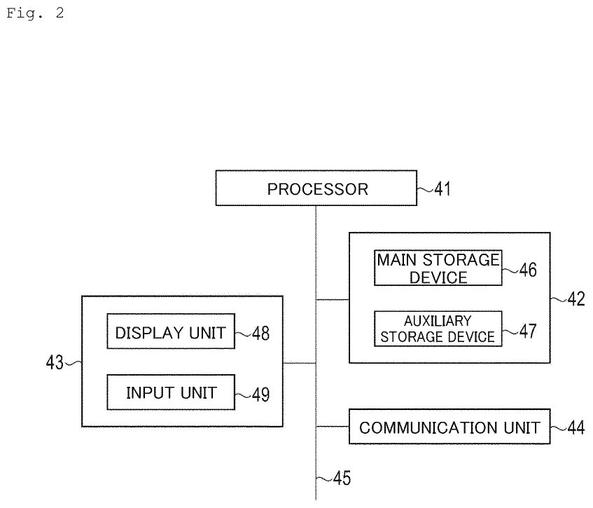

FIG. 2 is a block diagram schematically illustrating a hardware configuration of the transmission system and the reception system of the transfer system according to the embodiment. Each of the transmission system 2 and the reception system 3 is, for example, a computer. Each of the transmission system 2 and the reception system 3 includes a processor 41, a storage medium 42, a user interface 43, and a communication unit 44. The processor 41, the storage medium 42, the user interface 43, and the communication unit 44 are connected to each other via a bus 45.

The processor 41 includes any one of a central processing unit (CPU), a graphics processing unit (GPU), an application specific integrated circuit (ASIC), a microcomputer, a field programmable gate array (FPGA), and a digital signal processor (DSP). The storage medium 42 may include an auxiliary storage device 47, in addition to a main storage device 46 such as a memory.

The main storage device 46 is a non-temporary storage medium. The main storage device 46 is, for example, a nonvolatile memory such as a hard disk drive (HDD) or a solid state drive (SSD) in which writing and reading are possible at any time, or a nonvolatile memory such as a read only memory (ROM). Further, a combination of these nonvolatile memories may be used. The auxiliary storage device 47 is a tangible storage medium. The auxiliary storage device 47 is used as the above-described nonvolatile memory and a volatile memory such as random access memory (RAM) in combination. In the transmission system 2 and the reception system 3, only one processor 41 and one storage medium 42 may be provided, or a plurality of processor 41 and a plurality of storage media 42 may be provided.

In each of the transmission system 2 and the reception system 3, the processor 41 performs processing by executing a program or the like stored in the storage medium 42 or the like. In the transmission system 2 and the reception system 3, the programs executed by the processors 41 may be stored in a computer (server) connected via a network such as the Internet, a server in a cloud environment, or the like. In this case, the processor 41 downloads a program via the network. In the transmission system 2, the video processing unit 23, the audio system 24, the encoder 25, the determination unit 26, and the information collection unit 27 perform at least some of the processing executed by the processor 41 included in the transmission system 2. In the reception system 3, the decoder 31, the synchronization control unit 32, and the audio system 33 perform at least some of the processing performed by the processor 41 included in the reception system 3.

In the user interface 43, various operations or the like are input by the user of the transfer system 1, and information or the like that the user is notified of is provided by display or the like. The user interface may be a display unit 48 such as a display, or an input unit 49 such as a touch panel or keyboard. As the input unit 49, a device connected to the transmission system 2 and the reception system 3 may be used, or an input unit of another information processing device capable of communicating via the network 4 may be used.

In one example, the transmission system 2 and the reception system 3 are servers that can communicate with each other via the network 4. In another example, the transmission system 2 and the reception system 3 are cloud servers constructed in the cloud environment. In this case, an infrastructure of the cloud environment is configured of virtual processors such as virtual CPUs, and a cloud memory. The video processing unit 23, the audio system 24, the encoder 25, the determination unit 26, and the information collection unit 27 execute some of the processing that is executed by the virtual processor. Further, the decoder 31, the synchronization control unit 32, and the audio system 33 execute some of the processing that is executed by the virtual processor.

A configuration of the transmission system 2 will be described. The photographing unit 21 captures video (moving image) data. The photographing unit 21 is, for example, a camera. The audio collection unit 22 collects audio data used in the video data captured by the photographing unit 21. The audio collection unit 22 is, for example, a microphone. The video processing unit 23 executes predetermined processing on the basis of the video data captured by the photographing unit 21. The video processing unit 23 executes, for example, processing of displaying character information, graphic information, and the like superimposed on the captured video data. The audio system 24 executes predetermined processing on the basis of the audio data collected by the audio collection unit 22. The audio system 24, for example, executes processing of adjusting a volume or the like of the collected audio data to a state most appropriate for transfer via the network 4. The encoder 25 performs encoding on the basis of the video data input from the video processing unit 23 and the audio data input from the audio system 24. The encoder 25 transmits the encoded video data and audio data to the reception system 3 via the network 4.

The encoder 25 transmits both synchronous audio data capable of outputting audio in synchronization with the video data and asynchronous audio data capable of outputting audio independently of the video data to reception system 3 via the network 4. Both the synchronous audio data and the asynchronous audio data are audio data collected by the audio collection unit 22. Here, audio data transmitted to the reception system 3 in synchronization with the video data (together with the video data) is referred to as synchronous audio data. Further, audio data transmitted to the reception system 3 without relation to (independently of) the video data is referred to as asynchronous audio data. In the present embodiment, the encoder 25 collectively transmits the video data and the synchronous audio data to the reception system 3, and transmits the asynchronous audio data to the reception system 3 independently of the video data. Therefore, the asynchronous audio data is transmitted to the reception system 3 without being affected by processing of the video data, a transmission speed of the video data in the network 4, and the like. The determination unit 26 determines necessity of synchronization on the basis of the video data captured by the photographing unit 21 and the audio data collected by the audio collection unit 22. The information collection unit 27 collects the determination results generated by the determination unit 26, associates the determination results with determination items used for the determination, and transmits these to the reception system 3 via the network 4.

A configuration of the reception system 3 will be described. The decoder 31 decodes the video and the audio. The decoded video data is output to the video display unit 34 and the decoded audio data is output to the synchronization control unit 32. In this case, the synchronization control unit 32 acquires both synchronous audio data and asynchronous audio data from the decoder 31. The synchronization control unit 32 acquires synchronization control data in which the determination results are associated with the determination items from the transmission system 2. The synchronization control unit 32 executes processing to be described below on the basis of the synchronization control data, and selects any one of the synchronous audio data and the asynchronous audio data. The synchronization control unit 32 outputs the selected audio data to the audio system 33. The audio system 33 executes predetermined processing on the basis of the input audio data. The audio system 33, for example, executes processing of adjusting a volume so that the volume is suitable for reproduction from the audio generation unit 35. The video display unit 34 displays the input video data. The video display unit 34 is, for example, a display or a projector. The audio generation unit 35 reproduces the input audio data. The audio generation unit 35 is, for example, a speaker.

Next, the determination unit 26 and the information collection unit 27 of the transmission system 2 will be described. The determination unit 26 includes the video determination unit 261, the audio determination unit 262, the setting determination unit 263, and the volume determination unit 264, as described above.

The video determination unit 261 acquires video data used for determination from the photographing unit 21. The video determination unit 261 determines a type of video on the basis of the acquired video data. In one example, the video determination unit 261 determines whether the video is a pull-up image or a close-up image on the basis of the acquired video data. The video determination unit 261 may determine the above-described video data, for example, on the basis of the result of prior learning of machine learning. The video determination unit 261 outputs a video data determination result to the information collection unit.

The audio determination unit 262 acquires the audio data used for determination from the audio collection unit 22. The audio determination unit 262 determines the type of audio on the basis of the acquired audio data. In one example, the audio determination unit 262 determines whether or not the voice is cheering on the basis of the acquired audio data. The audio determination unit 262 may determine the audio data described above, for example, on the basis of a result of prior learning of machine learning. The audio determination unit 262 outputs an audio data determination result to the information collection unit 27.

The setting determination unit 263 acquires, for example, setting information of the photographing unit 21 from the photographing unit 21 as equipment data. The setting information includes information on a focal length of a lens. The setting determination unit 263 determines whether the photographing unit 21 is capturing a close-up image or the photographing unit 21 is capturing a pull-up image, on the basis of the acquired setting information and a preset threshold value. That is, a determination is made that the photographing unit 21 is capturing a close-up image when the focal length of the lens is larger than a preset threshold value, and a determination is made that the photographing unit 21 is photographing a pull-up image when the focal length of the lens is equal to or smaller than the preset threshold value. The setting determination unit 263 outputs the determination result of the photographing unit 21 to the information collection unit 27 and outputs the setting information of the photographing unit 21 to the information collection unit 27. The preset focal length threshold value of the lens is, for example, 100 mm when the photographing unit 21 is a camera with an image sensor of 35 mm.

The volume determination unit 264 acquires audio data used for determination from the audio collection unit 22. The volume determination unit 264 determines a type of audio on the basis of a volume of the acquired audio data. In one example, the volume determination unit 264 determines whether or not the audio data is cheering on the basis of the volume of the acquired audio data and a preset volume threshold value. The volume of the audio data includes, for example, information indicating a gain value (volume) of cheering input from microphones installed in seats for audiences. The volume determination unit 264 outputs a determination result of the volume of the audio data to the information collection unit 27. The preset volume threshold value is, for example, 75.0 dB.

The information collection unit 27 acquires the video data determination result, the audio data determination result, and the determination result based on the equipment data from the determination unit 26 described above. The information collection unit 27 associates information indicating that a determination result of the video determination unit 261 is related to the video data with the determination result of the video determination unit 261. The information collection unit 27 associates information indicating that the determination result of the audio determination unit 262 is related to the audio data with the determination result of the audio determination unit 262. The information collection unit 27 associates information indicating that the determination result of the setting determination unit 263 is related to the equipment data with the determination result of the setting determination unit 263. The information collection unit 27 associates information indicating that the determination result of the volume determination unit 264 is related to the audio data with the determination result of the volume determination unit 264. The information collection unit 27 transmits the synchronization control data in which the determination results are associated with the determination items, to the synchronization control unit 32 via the network 4 as described above.

Next, the synchronization control unit 32 will be described. The synchronization control unit 32 selects the audio data output from the audio generation unit 35 of the reception system 3 on the basis of the synchronization control data. The synchronization control unit 32 selects appropriate audio data by executing processing corresponding to the determination item and determination result included in the synchronization control data. When the determination item is related to the video data and the type of video is a close-up image as the determination result, the synchronization control unit 32 selects the synchronous audio data as audio data to be output. Further, when the determination item is related to the audio data and the determination result indicates that the type of audio is a thing other than cheering, the synchronization control unit 32 selects the synchronous audio data as the audio data to be output. Further, when the determination item is related to equipment data and the focal length exceeds the threshold value as a determination result, the synchronization control unit 32 selects the synchronous audio data as audio data to be output. Further, when the determination item is related to the audio data and the volume of the audio data exceeds the threshold value as the determination result, the synchronization control unit 32 selects the synchronous audio data as audio data to be output. In these cases, since a low delay is not required in transfer of the audio data with respect to the transfer of the video data, the synchronization control unit 32 selects the synchronous audio data as audio data to be output. In other cases, the synchronization control unit 32 selects the asynchronous audio data as the audio data. That is, in this case, since a low delay is required in the transfer of the audio data with respect to the transfer of the video data, the synchronization control unit 32 selects the asynchronous audio data as the audio data to be output. The synchronization control unit 32 outputs the audio data selected as described above to the audio system 33. In the above-described processing, the synchronization control unit 32 may use either one of the determination items and determination results included in the synchronization control data, or may use a plurality of these in combination.

The synchronization control unit 32 acquires reference information serving as a determination reference for audio data from the reception system 3 in advance. The reference information includes, for example, data such as a threshold value used for a determination of synchronization between the video data and the audio data, and a determination cycle (time interval) at which the determination of the synchronization is executed. The threshold value used for a determination of synchronization is, for example, that a percentage of determination results in which the synchronous audio data is selected is 50% or more when a plurality of determination results are used to determine whether or not selection of the synchronous audio data is required. In this case, the synchronous audio data is selected when a percentage of the determination results in which the synchronous audio data is selected is 50% or more, and the asynchronous audio data is selected when the percentage of the determination results that select the synchronous audio data is less than 50%. Further, the determination cycle is 1/60 seconds when the photographing unit 21 is a camera that photographs 60 videos per second, for example.

When the synchronization control unit 32 selects the audio data, the audio data may be switched from the synchronous audio data to the asynchronous audio data, or from the asynchronous audio data to the synchronous audio data before and after the selection. In this case, the synchronization control unit 32 may execute predetermined buffering processing in order to suppress unnatural change in an audio (for example, occurrence of silent sections or ruptures in an audio waveform) according to switching of the audio data. For example, the buffer processing is not processing for performing instantaneous switching at the time of switching the audio data, but is processing for combining gradually decreasing the volume of the audio data before switching and gradually increasing the volume of the audio data after switching, and performing outputting.

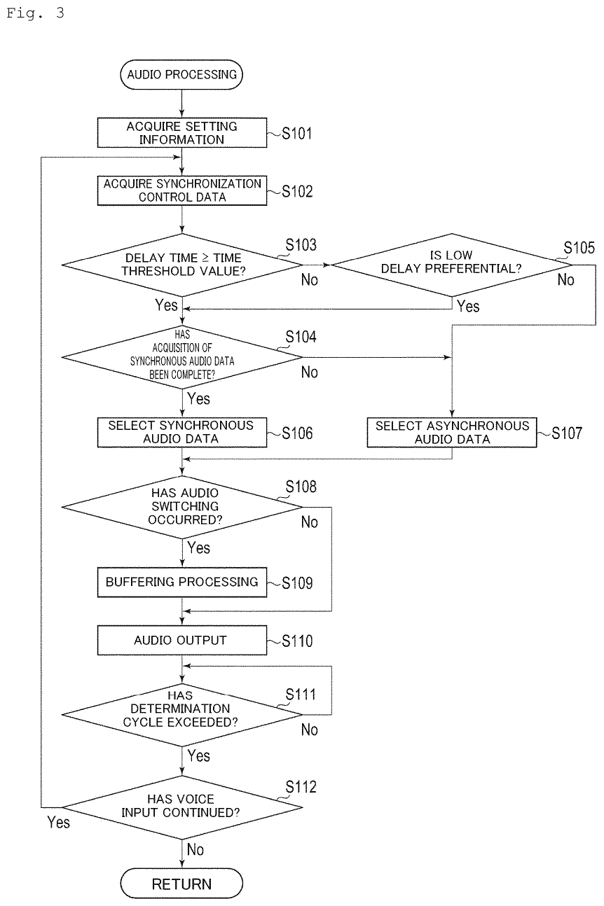

FIG. 3 is a flowchart illustrating an example of processing that is executed by the synchronization control unit 32. The processing in FIG. 3 is executed by the synchronization control unit 32 each time the video data and the audio data are input from the transmission system 2 to the reception system 3. Therefore, the processing in FIG. 3 is an example of processing that is executed in input of the audio data to the transfer system 1.

When the processing of FIG. 3 is started, the synchronization control unit 32 acquires reference information serving as a determination reference for the audio data, from the reception system 3 (S101). The synchronization control unit 32 acquires the synchronization control data in which the determination results are associated with the determination items, from the transmission system 2 via the network 4 (S102). When a time (delay time) required for transfer of the video data and the audio data from the transmission system 2 to the reception system 3 is equal to or greater than a time threshold value (S103—Yes), the synchronization control unit 32 determines whether or not acquisition of the synchronization audio data is completed (S104). When the acquisition of the synchronous audio data has been completed (S104—Yes), the synchronization control unit 32 selects the synchronous audio data as audio data to be output (S106). When the acquisition of the synchronous audio data has not been completed (S104—No), the synchronization control unit 32 selects the asynchronous audio data as the audio data to be output (S107). Thus, when the delay time is equal to or greater than the time threshold value, audio data whose acquisition has been completed is selected as audio data to be output, making it possible to prevent audio reproduction from being stopping.

When the time (delay time) required for transfer of the video data and the audio data from the transmission system 2 to the reception system 3 is less than the time threshold value (S103—No), the synchronization control unit 32 determines whether or not the audio data with a low delay is preferential (S105). Whether or not a low delay is preferential is determined according to the determination results and determination items included in the synchronization control data, as described above. When the low delay is preferential (S105—Yes), the processing proceeds to S104, and processing after S104 is executed. When the low delay is not preferential (S105—No), the synchronization control unit 32 selects the asynchronous audio data as the audio data to be output (S107).

The synchronization control unit 32 determines whether or not switching between the audio data before selection and the audio data after selection is performed through selection of the audio data to be output (S108). When the audio data is switched (S108—Yes), the synchronization control unit 32 executes the above-described buffering processing (S109). Thereafter, the synchronization control unit 32 outputs the buffered audio data (S110). When the audio data has not been switched (S108—No), the processing proceeds to S110 without the synchronization control unit 32 executing S109. When the audio data is output, the audio data is input to the audio system 33, and the audio is output from the audio generation unit 35. Further, the audio output from the audio generation unit 35 is appropriately executed according to reproduction of the video data in the video display unit 34.

The synchronization control unit 32 determines whether or not the determination cycle of the audio data acquired as the reference information is exceeded (S111). When the determination cycle has not been exceeded (S111—No), the processing returns to S111, and the synchronization control unit 32 executes the processes after S111. When the determination cycle has been exceeded (S111—Yes), the synchronization control unit 32 determines whether or not the audio data input continues (S112). When the input of the audio data continues (S112—Yes), the processing returns to S102, and the synchronization control unit 32 executes the processing after S102. When the input of the audio data has not continued (S112—No), the processing ends.

As described above, the transfer system 1 of the present embodiment includes the information collection unit 27 and the synchronization control unit 32. The information collection unit 27 associates the determination result on the necessity of the synchronization between the video and the audio with the determination item, and collects these as the synchronization control data. The synchronization control unit 32 selects any one of the synchronous audio data capable of outputting an audio in synchronization with a video and asynchronous audio data capable of outputting the audio independently of the video, on the basis of the synchronization control data. This makes it possible for the transfer system 1 to output the asynchronous audio data at an appropriate timing. Therefore, in the transmission system of the present embodiment, the audio is transferred without waiting for transfer of the video, making it possible to suppress the audio delay to, for example, 50 milliseconds or less. This makes possible for people watching or viewing a game from remote places to cheer together.

In the transfer system 1 of the present embodiment, it is preferable for the synchronization control unit 32 to select the synchronous audio data when the synchronization control data is information requesting a low audio delay, and to select asynchronous audio data when the synchronization control data is information not requiring a low audio delay. This makes it possible for the transfer system 1 to output the asynchronous audio data that is not synchronized with the video at an appropriate timing.

In the present transfer system 1 of the embodiment, it is preferable for the synchronization control unit 32 to execute audio buffering processing when output audio is switched between the synchronous audio data and the asynchronous audio data through selection based on the synchronization control data. This makes it possible to suppress generation of an unnatural audio caused by the switching of the audio data, and for a viewer to continue to view the video and the audio without discomfort.

With such a transfer system 1, for example, when a video is a close-up image (for example, when an athlete is zoomed in and photographed), a video and an audio are reproduced in synchronization, and when a video is switched and is a pull-up image (for example, when all seats for audiences are photographed), the video and the audio are reproduced with synchronization. Therefore, the viewer of the video can continue viewing without feeling uncomfortable because the video and the audio are synchronized at a timing when the viewer of the video noticeably recognizes a discrepancy between the video and the audio. Further, since the video and the audio are reproduced without being synchronized at a timing different from the timing at which the viewer of the video noticeably recognizes the discrepancy between the video and the audio, it is possible to suppress a delay associated with the video and the audio without any discomfort to the viewer.

### Modification Example

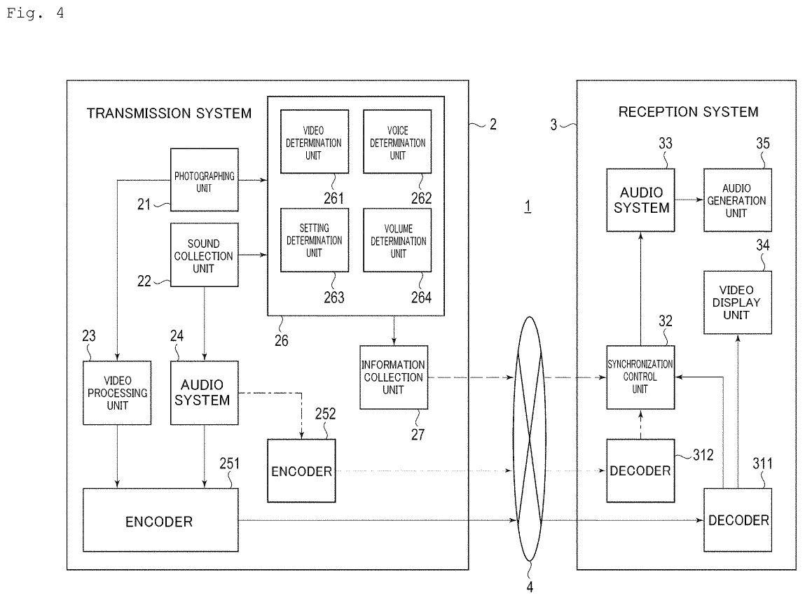

FIG. 4 is a schematic block diagram illustrating a modification example of the transfer system of the embodiment. In this modification example, a plurality of encoders 25 are provided in the transmission system 2 and a plurality of decoders 31 are provided in the reception system 3. In one example of FIG. 4, the transmission system 2 includes two encoders 251 and 252 and the reception system 3 includes two decoders 311 and 312. In this case, the encoder 251 synchronizes the video data output from the video processing unit 23 to the audio data output from the audio system 24, and transmits these from the transmission system 2 to the reception system 3 via the network 4 (indicated by a solid arrow). Further, the encoder 252 transmits the asynchronous audio data output from the audio system 24, from the transmission system 2 to the reception system 3 via the network 4 independently without synchronization with the video data (indicated by a dashed-dotted arrow). On the other hand, the decoder 311 decodes the received video data and synchronous audio data, outputs the video data to the video display unit 34, and outputs the synchronous audio data to the synchronization control unit 32 (indicated by a solid arrow). Further, the decoder 312 outputs the received asynchronous audio data to the synchronization control unit 32 (indicated by a dashed-dotted arrow). Also in this modification example, the transfer system 1 can select either the synchronous audio data or the asynchronous audio data on the basis of the synchronous control data. Therefore, even in these modification examples, the same effects as those in the above-described embodiment are obtained.

In a modification example, the information collection unit 27 and the synchronization control unit 32 may be provided in the transmission system 2. Further, in another modification, the information collection unit 27 and the synchronization control unit 32 may be provided in the reception system 3. In the case of these modification examples, the synchronization control unit 32 acquires the synchronization control data from the information collection unit 27 without passing through the network 4. Also in these modification examples, the transfer system 1 can select any one of the synchronous audio data and the asynchronous audio data on the basis of the synchronous control data. Therefore, even in these modification examples, the same effect as the above-described embodiment can be obtained.

A scheme described in the embodiment or the like can be stored in a storage medium such as a magnetic disk, an optical disc, a semiconductor memory, or the like and distributed as a program (software) that can be executed by a computer. The storage medium is not limited to those for distribution, and includes storage media such as a magnetic disk and a semiconductor memory provided inside a computer or in a device connected via a network. Further, the scheme described in the embodiments may be transferred and distributed over a communication medium. The programs stored on the medium also include a configuration program for constructing, in a computer, software to be executed by the computer. The software includes not only execution programs but also tables and data structures. The computer that realizes this system reads the program recorded in the storage medium and executes the above-described processing by an operation being controlled by software. The software may be constructed by the computer using the configuration program.

The present invention is not limited to the above embodiment, and can be modified in various ways without departing from the gist thereof at an implementation stage. Further, respective embodiment may be combined appropriately and implemented and, in this case, combined effects can be achieved. Further, the foregoing embodiment include various inventions, and various inventions can be extracted by combinations selected from the plurality of components disclosed herein. For example, as long as the problem can be solved and the effects can be achieved even when several of the components described in the embodiment are removed, a configuration in which the components have been removed can be extracted as an invention.

### REFERENCE SIGNS LIST

1 Transfer system
2 Transmission system
3 Reception system
4 Network
21 Photographing unit
22 Audio collection unit
23 Video processing unit
24 Audio system
25, 251, 252 Encoder
26 Determination unit
27 Information collection unit
31, 311, 312 Decoder
32 Synchronisation control unit
33 Audio system
34 Video display unit
35 Audio generation unit

1. A transfer system, comprising:
a transmission system for transmitting video data and audio data to a connected network:
a reception system for receiving the video data and the audio data via the network:
information collection circuitry in the transmission system or the reception system, and configured to associate a determination result on necessity of synchronization between a video and audio with a determination item of the determination result to collect these as synchronization control data; and
synchronization control circuitry in the transmission system or the reception system and configured to select any one of the synchronous audio data for outputting audio in synchronization with a video and asynchronous audio data for outputting the audio independently of the video, on the basis of the synchronization control data.

2. The transfer system according to claim 1, wherein;
the synchronization control circuitry selects the synchronous audio data when the synchronization control data is information requiring a low audio delay, and selects the asynchronous audio data when the synchronization control data is information not requiring the low audio delay.

3. The transfer system according to claim 1, wherein:
the synchronization control circuitry executes audio buffering processing when audio to be output is switched between the synchronous audio data and the asynchronous audio data through selection based on the synchronization control data.

4. The transfer system according to claim 1, wherein:
the synchronization control data includes at least one selected from the synchronization control data related to the video data, the synchronization control data related to the audio data, and the synchronization control data related to equipment data.

5. The transfer system according to claim 1, wherein:
the transmission system includes the information collection circuitry,
the reception system is a system different from the transmission system and includes the synchronization control circuitry, and
the synchronization control circuitry acquires the synchronization control data from the information collection circuitry.

6. (canceled)

7. A reception system for receiving video data and audio data from a connected network, the reception system comprising:
synchronization control circuitry configured to select any one of the synchronous audio data for outputting audio in synchronization with a video and asynchronous audio data for outputting the audio independently of the video, on the basis of synchronization control data in which a determination result on necessity of synchronization of a video and audio is associated with a determination item of the determination result.

8. A transfer method, comprising:
associating a determination result on necessity of synchronization between a video and audio with a determination item of the determination result to collect these as synchronization control data; and
selecting any one of the synchronous audio data for outputting audio in synchronization with a video and asynchronous audio data for outputting the audio independently of the video, on the basis of the synchronization control data.
